(19) United States
(12) Patent Application Publication
(10) Pub. No.: US 2005/0083684 A1
(43) Pub. Date: Apr. 21, 2005

(54) Utility light with brackets

(76) Inventors: James D. Kovacik, Brecksville, OH (US); Paul S. Blanch, Broadview Heights, OH (US); Joseph J. Smith, Wooster, OH (US)

Correspondence Address: MACMILLAN SOBANSKI & TODD, LLC;ONE MARITIME PLAZA FOURTH FLOOR, 720 WATER STREET, TOLEDO, OH, 43604-1619, US

(21) Appl. No.: 10/689,251

(22) Filed: Oct. 20, 2003

(51) Int. Cl. F21S 4/00

(52) U.S. Cl. 362/217

(57) ABSTRACT

A utility light assembly containing a fluorescent lamp housed within a protective translucent hollow cylindrical body. Hooks are provided for hanging the assembly and releasable brackets are provided for supporting the assembly on a planar surface.

### BACKGROUND OF THE INVENTION

The present invention relates generally to utility lights and, more particularly, to a fluorescent utility light which may be mounted in a single workstation, for example, or manually moved from site to site.

Portable lights which can be manually moved and suspended about a work site to aid a user to obtain desirable lighting conditions are well known. It has been the practice to use incandescent light bulbs, suitably encased in light guards, for this purpose. Such lights are often referred to as trouble lamps, extension lights, work lights, inspection lights, and the like, and are commonly employed by mechanics and other workers who require a concentration of lights in a frequently changing location. Such a trouble light is shown in the U.S. Pat. No. 4,774,647 to Kovacik et al.

Fluorescent lights have several advantages in use as compared with the incandescent bulbs. As an example, for the same wattage fluorescent lights usually provide more light with less glare. In the past, attempts have been made to convert portable lights such as extension lights to fluorescent tubes. However, a number of serious problems have arisen, particularly in attempting to adapt a fluorescent tube to a satisfactory portable assembly. A common complaint is that the electrical connections between a fluorescent tube and its mounting and electrical conductors are not originally, or do not long remain, sufficiently tight to provide desired electroconductivity, as compared to the more commonly used incandescent light bulbs. When inadequate electrical contacts occur, fluorescent tubes exhibit disproportionately high electrical resistance.

It is, of course, quite important that a fluorescent tube be firmly mounted and snugly held by its supports, especially if the tube is designed for portable use. While an incandescent bulb has a relatively large area of contact for electrical connection around its threaded base, the usual fluorescent tube has only a pair of relatively fine, fragile pins extending from opposite ends of the tube which constitute electrical terminals. In order to ensure a firm and constant electrical connection with the terminal pins, prior socket connections have been quite heavy and cumbersome. In some instances, sockets used for each set of pin terminals are mounted apart facing each other as on a single bracket somewhat longer than the fluorescent tube itself. Such sockets are usually stationary and not movable with respect to each other. Such a restriction often limits the manner in which the fluorescent tube can be mounted and used.

Additionally, it has been the practice to mount a ballast for the fluorescent tube in-line in the electrical cord which energizes the tube. The ballast which includes a transformer is normally quite heavy, which adds to the problems of supporting and mounting the fluorescent tube. Further, a ballast generates heat in use and the added heat, so generated, can be a problem when adjacent to the tube.

These structural problems become even more acute in portable fluorescent tube assemblies. Portable units are much more susceptible to rough handling. The tube assembly may be dropped, subjected to jarring, vibration, and the like. Such mechanical shocks tend to dislodge or momentarily interrupt an electric current to the tube pins at the opposite ends of the tube and produce a high voltage arc, thereby introducing health and safety hazards.

The U.S. Pat. No. 4,262,327 shows a portable fluorescent tube having a lens and a hook for hanging the assembly. The assembly includes a tubular envelope surrounding a standard fluorescent tube and closed by a pair of end sockets. One of the end sockets has a starter switch mounted thereon and a ballast is connected in an electrical supply line near an electrical plug. However, in order to change the fluorescent tube, such a light assembly must be disassembled.

The U.S. Pat. No. 5,921,658 shows a fluorescent utility light including an elongate body having a curved handle and an upper portion with a removable transparent lens for enclosing a fluorescent lamp in a socket. A reflector in the body directs light from the lamp through a front wall and side walls of the lens. A movable hook is provided at an upper end of the body and a power cord for the lamp extends through a bottom wall of the handle. An electrical socket also is provided in the bottom wall of the handle such that an electrical cord plugged into the socket extends generally parallel to the power cord. A magnet on a clip engages a groove formed in a central portion of the body and the clip and the magnet can be rotated about the body to various detent positions. A plurality of sawtooth ridges formed on an interior surface of a top wall of the lens captures light from the lamp and directs it through the top wall of the lens.

It is an object of the present invention to produce a fluorescent utility light which may be mounted for use in a temporary or permanent work site, or may be readily conveyed from site to site in a portable fashion.

### SUMMARY OF THE INVENTION

The above, as well as other objects of the invention, may typically be achieved by a fluorescent utility light comprising: an elongate hollow cylindrical body formed of a translucent material having a first end and a spaced apart second end; an elongate fluorescent lamp disposed within the body and having a first end with extending conductor pins and a spaced apart second end with extending conductor pins; a first socket for receiving the pins of the first end of the lamp; a cap secured to the first end of the cylindrical body for containing the first socket within the first end of the body; a second socket for receiving the pins of the second end of the lamp; a handle secured to the second end of the cylindrical body for containing the second socket within the second end of the body; electrical conductor providing electrical communication between a source of electrical energy and the lamp, the conductor extending through the handle; and support means attached to the cap and the handle for supporting the assembly.

### BRIEF DESCRIPTION OF THE DRAWINGS

The above, as well as other objects and advantages of the present invention, will become readily apparent to those skilled in the art from the following detailed description of a preferred embodiment when considered in the light of the accompanying drawings in which:

FIG. 1 is an exploded perspective view of a fluorescent utility light in accordance with the present invention;

FIG. 2 is a front elevational view of the assembled form of the utility light illustrated in FIG. 1;

FIG. 3 is a left side elevational view of the utility light illustrated in FIG. 2;

FIG. 4 is a right side elevational view of the utility light illustrated in FIG. 2; and

FIG. 5 is a sectional view of the utility light taken along lines 5-5 in FIG. 3.

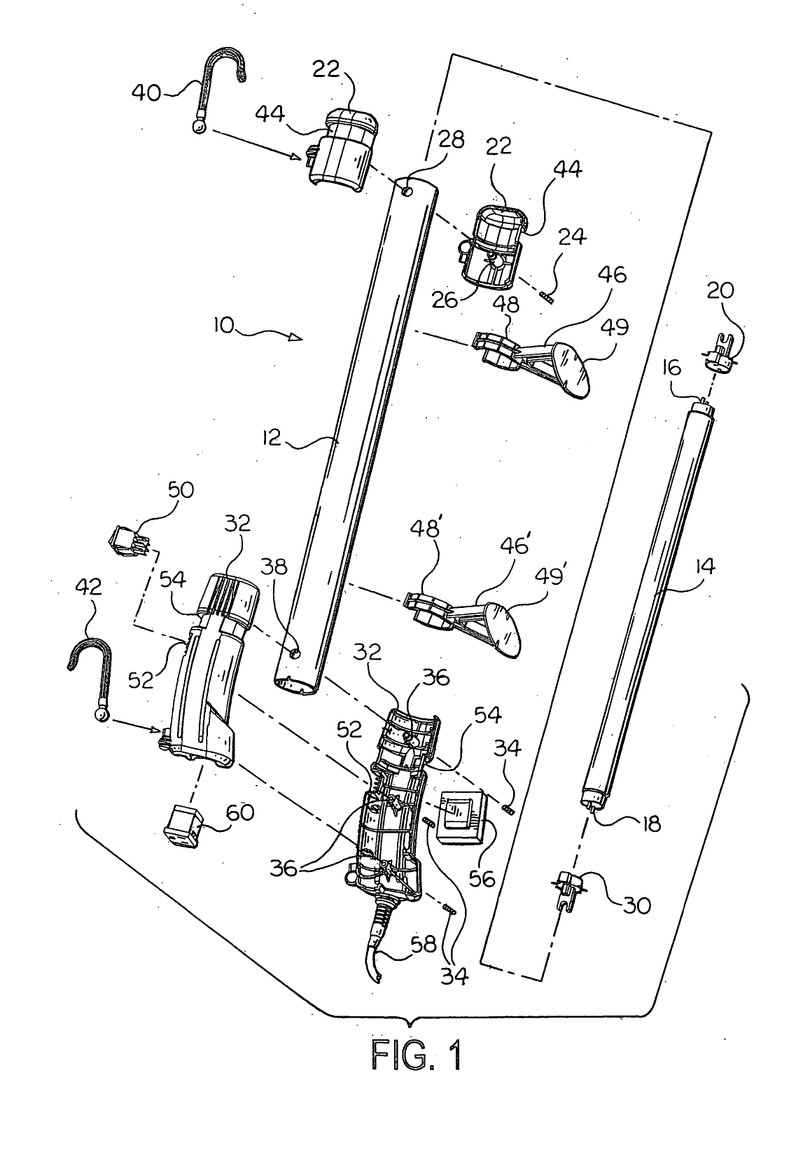

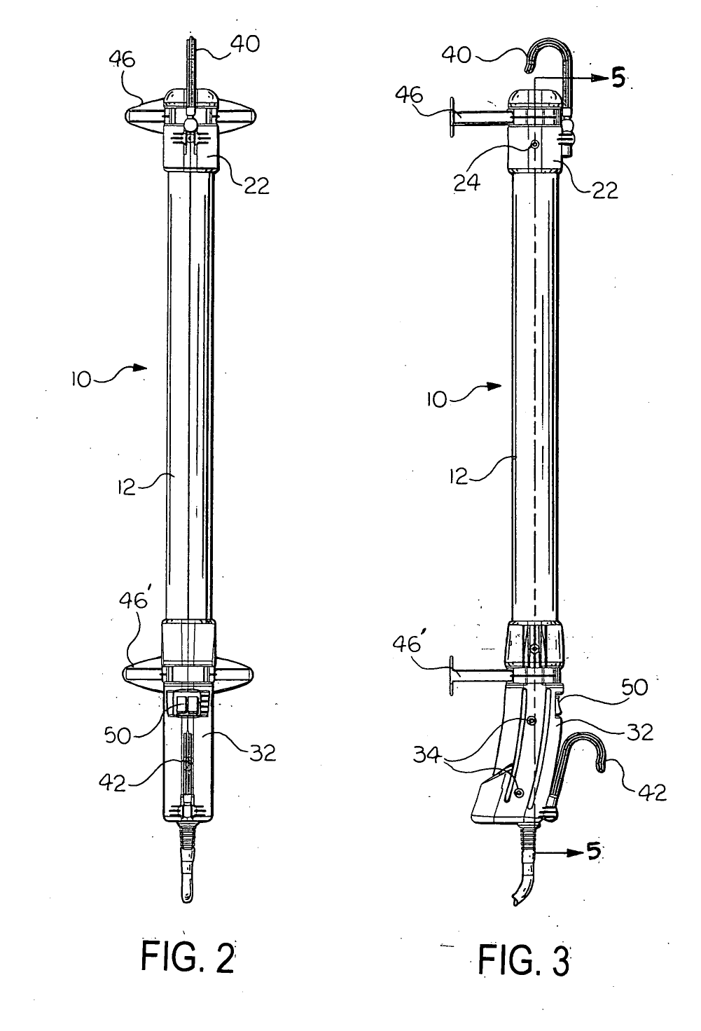

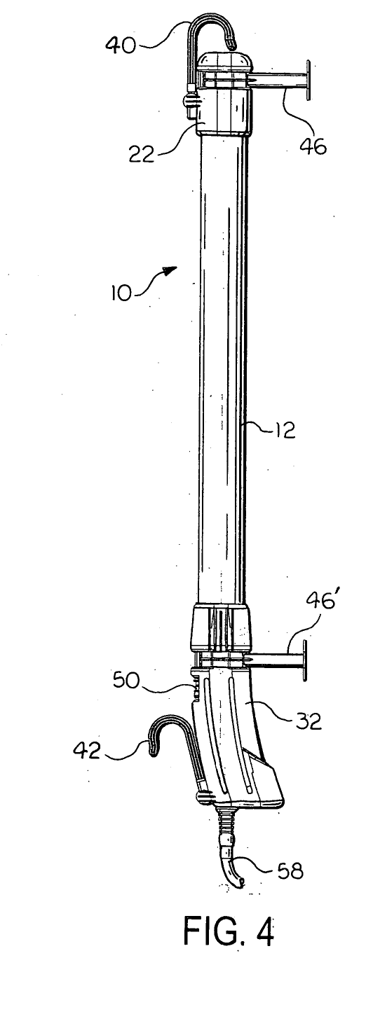

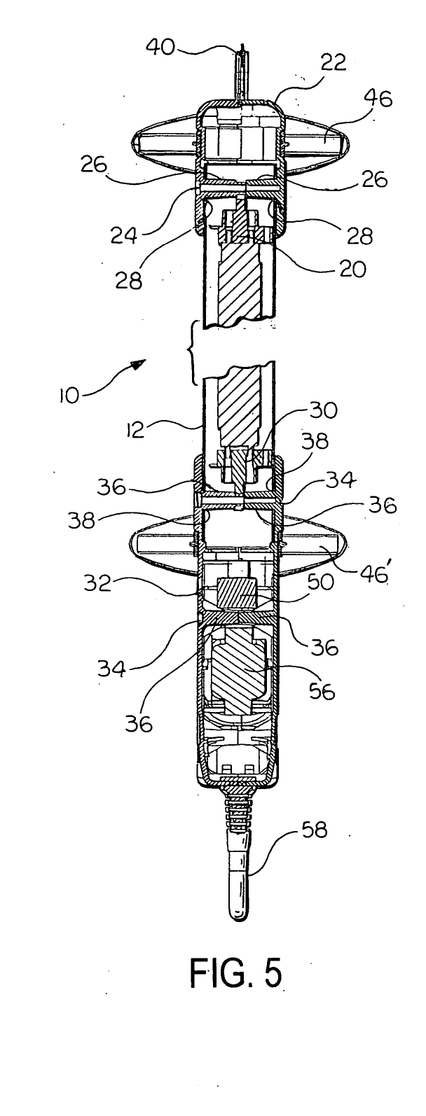

### DESCRIPTION OF THE PREFERRED EMBODIMENT

There is shown in the drawings a fluorescent utility light 10 in accordance with the present invention. The utility light 10 has an elongate hollow cylindrical body 12 formed of a translucent material. Typically the material is plastic.

An elongate fluorescent tube 14 is adapted to be received within the hollow interior of the body 12. The tube 14 is provided with a set of conductor pins 16 extending from a first end and a set of conductor pins 18 extended from the second end.

A socket 20 for receiving the pins 16 of the fluorescent tube 14 is disposed in one end of the body 12. The socket 20 is secured within the interior of the hollow body 12 by a cap 22 formed of a pair of cooperating sections. The sections of the cap 22 are typically fastened together by a threaded fastener 24. The cap sections include a pair of inwardly extending bosses 26 that are received by apertures 28 formed in the body 12 and function to receive the threaded fastener 24 and secure the socket 20 within the interior of the hollow body 12.

Another socket 30 for receiving the pins 18 of the fluorescent tube 14 is disposed in the opposite end of the body 12. The socket 30 is secured within the interior of the hollow body 12 by a handle 32 formed of a pair of cooperating sections. The sections of the handle 32 are typically fastened together by threaded fasteners 34. A plurality of inwardly extending bosses 36 are provided to receive the threaded fasteners 34 in a well known manner. The uppermost pair of inwardly extending bosses 36 of the handle 32 also function to secure the socket 30 in place, as well as, extend through suitable apertures 38 in the hollow body 12 at the end opposite to the apertures 28.

Supporting hooks 40 and 42 are mounted to the light assembly at opposite ends thereof. The hooks 40 and 42 are pivotally mounted to the cap 22 and the handle 32, respectively. In the illustrated embodiment, the hooks 40 and 42 are mounted by way of ball and socket-type hinge structures. One such structure is illustrated and described in U.S. Pat. No. 5,921,658. The hooks 40 and 42 may be utilized for supporting the light assembly during storage or use, for example.

The cap 22 is provided with a circumferential channel 44 which is adapted to receive a bracket in the form of a light holder clip stand 46. The clip stand 46 includes a generally C-shaped clip 48 which is formed of resilient material to enable the ends of the clip 48 to part sufficiently to be received within the channel 44 and to then closed to snuggly engage the channel 44 of the cap 22. The clip stand 46 also includes a generally planar base 49 for engaging a support surface.

Similarly, a channel 54 is formed in the handle 32 to receive a C-shaped clip 48′ of another light holding clip stand 46′. The brackets in the form of the clip stands 46 and 46′ are substantially identical and are typically formed of a plastic material. Once the clip stands 46 and 46′ are suitably mounted to the light assembly, the stands may be rotated about the assembly to any desired position, thus providing adequate support for the assembly on a planar surface. For example, the bases 49 and 49′ can be used to support the light 10 on a horizontal surface. Also, the bases 49 and 49′ can be attached to a vertical surface by suitable fasteners to removably support the light 10 by selectively engaging and disengaging the clips 48 and 48′ with the channels 44 and 54 respectively. Magnetic clips, such as those shown in the U.S. Pat. No. 5,921,658 (incorporated herein by reference), can be substituted for the clip stands 46 and 46′.

A push button switch 50 is mounted in a suitable aperture 52 formed in the cooperating sections of the handle 32. The switch 50 is typically slightly recessed so as to be properly protected against accidental actuation.

Normal associated electrical components such as a ballast 56, an associated power line 58, and a female electrical receptacle 60 are suitably positioned in the handle portion of the light assembly.

The invention is more easily comprehended by reference to specific embodiments recited hereinabove which are representative of the invention. It must be understood, however, that the specific embodiments are provided only for the purpose of illustration, and that the invention may be practiced otherwise than as specifically illustrated without departing from its spirit and scope.

1. A utility light assembly comprising:
an elongate hollow cylindrical body formed of a translucent material having a first end and a spaced apart second end;
an elongate fluorescent lamp disposed within said body and having a first end with extending conductor pins and a spaced apart second end with extending conductor pins;
a first socket for receiving said pins of said first end of said lamp;
a cap secured to said first end of said body for retaining said first socket within said first end of said body;
a second socket for receiving said pins of said second end of said lamp;
a handle secured to said second end of said body for retaining said second socket within said second end of said body;
an electrical conductor for providing electrical communication between a source of electrical energy and said lamp, said conductor extending through said handle; and
a support means for supporting the assembly.

2. A utility light assembly as defined in claim 1 wherein said cap is formed of a pair of mating sections.

3. A utility light assembly as defined in claim 3 including a boss extending inwardly of each of said mating sections of said cap.

4. A utility light assembly as defined in claim 3 wherein said body is formed with apertures for receiving respective ones of said bosses.

5. A utility light assembly as defined in claim 3 wherein said first socket is maintained in said hollow cylindrical body by at least one of said bosses.

6. A utility light assembly as defined in claim 1 wherein said handle is formed of a pair of mating sections.

7. A utility light assembly as defined in claim 6 including a boss extending inwardly of each of said mating sections of said handle.

8. A utility light assembly as defined in claim 7 wherein said body is formed with apertures for receiving respective ones of said bosses.

9. A utility light assembly as defined in claim 1 wherein said support means includes at least one hook for holding the assembly in different positions of use.

10. A utility light assembly as defined in claim 9 wherein said at least one hook is pivotally mounted.

11. A utility light assembly as defined in claim 9 wherein said at least one hook is mounted to one of said cap and said handle.

12. A utility light assembly as defined in claim 1 wherein said support means includes at least one clip stand.

13. A utility light assembly as defined in claim 12 wherein said at least one clip stand is releasably attached to one of said cap and said handle.

14. A utility light assembly as defined in claim 12 wherein said at least one clip stand is rotatably attached to the assembly.

15. A utility light assembly comprising:
an elongate hollow cylindrical body formed of a translucent material having a first end and a spaced apart second end;
an elongate fluorescent lamp mounted within said body;
a cap secured to said first end of said body for retaining said lamp in said body;
a handle secured to said second end of said body for retaining said lamp in said body;
an electrical conductor for providing electrical communication between a source of electrical energy and said lamp, said conductor extending through said handle;
a pair of clip stands for supporting the assembly, one of said clip stands being releasably attached to said cap and another of said clip stands being releasably attached to said handle.

16. A utility light assembly as defined in claim 15 wherein reach of said clip stands is rotatably received in a groove formed in a corresponding one of said cap and said handle.

17. A utility light assembly as defined in claim 15 wherein each of said clip stands includes a C-shaped clip formed of a resilient material for releasably engaging a corresponding one of said cap and said handle.

18. A utility light assembly as defined in claim 15 including at least one hook for holding the assembly in different positions of use.

19. A utility light assembly as defined in claim 18 wherein said at least one hook is pivotally mounted.
